(19) United States
(12) Patent Application Publication
(10) Pub. No.: US 2007/0048008 A1
(43) Pub. Date: Mar. 1, 2007

(54) Photosensitive-member cartridge, developing cartridge, and image-forming device

(75) Inventor: Naoya Kamimura, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/500,357

(22) Filed: Aug. 8, 2006

(30) Foreign Application Priority Data
Aug. 23, 2005 (JP) P2005-240781

(51) Int. Cl. G03G 21/18

(52) U.S. Cl. 399/111

(57) ABSTRACT

A photosensitive-member cartridge has an upper registration roller, and both ends of the upper registration roller are rotatably supported on respective side walls of a casing by roller support members. Torsion coil springs are engaged with the roller support members and the side walls, and urge the upper registration roller upward. When the photosensitive-member cartridge is alone, the upper registration roller is held at a retract position with respect to a bottom wall of the casing without rattling.

### CROSS REFERENCE TO RELATED APPLICATIONS

This application claims priority from Japanese Patent Application No. 2005-240781 filed Aug. 23, 2005. The entire content of the priority application is incorporated herein by reference.

### TECHNICAL FIELD

The disclosure relates to a photosensitive-member cartridge including a conveying roller for conveying a recording medium, to a developing cartridge detachably mountable on such a photosensitive-member cartridge, and to an image forming device including a detachable process cartridge having a photosensitive-member cartridge and a developing cartridge detachably mountable on the photosensitive-member cartridge.

### BACKGROUND

There has been provided an image forming device that forms a visible image by supplying a developer to an electrostatic latent image formed on a photosensitive member and that transfers the visible image onto a recording medium. In this type of image forming device, in order to facilitate maintenance operation, a developing unit is configured as a developing cartridge that is detachably mounted on a main body of the image forming device. Because the time at which the photosensitive member becomes unusable due to deterioration with time differs from the time at which the developer is fully consumed, a photosensitive-member cartridge including the photosensitive member is provided separately from the developing cartridge so that these cartridges may be replaced according to their lifetime. These cartridges are attached to each other, forming a process cartridge, and the process cartridge is detachably mounted on the main body of the image forming device.

In Unexamined Patent-Application Publication No. 2001-75457, one of a pair of conveying rollers for conveying a recording medium is provided on the main body of the image forming device (hereinafter referred to as a “device-side conveying roller”), and the other one of the conveying rollers is provided on the photosensitive-member cartridge (hereinafter referred to as “cartridge-side conveying roller”). Therefore, the cartridge-side conveying roller separates from the device-side conveying roller by moving in the substantial horizontal direction when the process cartridge is detached from the main body of the image forming device.

Because the cartridge-side conveying roller needs to be properly brought into contact with the device-side conveying roller when the process cartridge is attached to the main body, the cartridge-side conveying roller is loosely supported on a cartridge casing of the photosensitive-member cartridge so as to be movable in the vertical direction with respect to the cartridge casing. For this reason, when the photosensitive-member cartridge is not mounted on the main body of the image forming device, the cartridge-side conveying roller rattles, thereby interrupting handling of the photosensitive-member cartridge. Also, when the cartridge-side conveying roller rattles, the cartridge-side conveying roller may protrude outside beyond the cartridge casing of the photosensitive-member cartridge due to its own weight.

### SUMMARY

In view of the forgoing, it is an object of the invention to solve the above-mentioned problems, and also so to provide a photosensitive-member cartridge that can be easily handled when being detached from an image forming device without rattling of a cartridge-side conveying roller, a developing cartridge that can be attached to the photosensitive-member cartridge, and an image forming device that mounts the photosensitive-member cartridge and the developing cartridge.

In order to attain the above and other objects, according to some aspects of the invention, there is provided a photosensitive-member cartridge attachable to an image forming device including a device-side roller. The photosensitive-member cartridge includes a photosensitive member on which an electrostatic latent image is formed, a casing that houses the photosensitive member, a conveying member, and a holding member. A developing cartridge including a developing member that develops the electrostatic latent image into a visible image is detachably attachable to the casing. The conveying member includes a cartridge-side roller supported on the casing so as to be movable relative to the casing. The cartridge-side roller conveys a recording medium in cooperation with the device-side roller. The holding member is disposed between the casing and the conveying member and holds the conveying member, wherein the holding member prevents the conveying member from rattling relative to the casing.

There is also provided a developing cartridge detachably attachable to a photosensitive-member cartridge. The photosensitive-member cartridge includes a photosensitive member on which an electrostatic latent image is formed, a casing that houses the photosensitive member, a conveying member including a cartridge-side roller that conveys a recording medium in cooperation with a device-side roller of an image-forming device and a support member that rotatably supports the cartridge-side roller, and a holding member that holds the conveying member. The developing cartridge includes a developing member that develops the electrostatic latent image formed on the photosensitive member of the photosensitive-member cartridge, and a pressing member that presses the conveying member of the photosensitive-member cartridge against holding force of the holding member of the photosensitive-member cartridge when the developing cartridge is attached to the photosensitive-member cartridge.

There is also provided an image-forming device including a device-side roller, a housing that supports the device-side roller, a photosensitive-member cartridge, a developing cartridge, and a resilient member. The photosensitive-member cartridge is detachably supported on the housing, and includes a photosensitive member on which an electrostatic latent image is formed, a cartridge casing that houses the photosensitive member, a conveying member, and an urging member. The conveying member includes a cartridge-side roller and a support member that rotatably supports the cartridge-side roller. The cartridge-side roller conveys a recording medium in cooperation with the device-side roller. The urging member urges the cartridge-side roller toward a retract position. The developing cartridge is detachably attached to the photosensitive-member cartridge, and includes a developing member that develops the electrostatic latent image formed on the photosensitive member into a visible image, and a pressing member that presses the cartridge-side roller against urging force of the urging member when the developing cartridge is attached to the photosensitive-member cartridge and the photosensitive-member cartridge is detached from the housing. The resilient member urges the cartridge-side roller against the device-side roller when the photosensitive-member cartridge and the developing cartridge are mounted to the housing. The urging force of the resilient member is greater than the urging force of the urging member.

### BRIEF DESCRIPTION OF THE DRAWINGS

Illustrative aspects in accordance with the invention will be described in detail with reference to the following figures wherein:

FIG. 1 is a schematic side sectional view of a laser printer according to illustrative aspects of the invention;

FIG. 2 is a perspective view of an upper registration roller attached with roller support members of the laser printer in FIG. 1;

FIG. 3(a) is a perspective view of one of the roller support members in FIG. 2;

FIG. 3(b) is a front view of the roller support member in FIG. 3(a);

FIG. 3(c) is a side view of the roller support member;

FIG. 3(d) is a side view of a torsion coil spring that is attached to the roller support member;

FIG. 3(e) is a perspective view of the torsion coil spring in FIG. 3(d);

FIG. 4 is a top view showing a photosensitive-member cartridge of the laser printer in FIG. 1;

FIG. 5 is an enlarged view of an encircled area in FIG. 4, wherein shaded areas are the roller support members;

FIG. 6 is a perspective view of the photosensitive-member cartridge with the upper registration roller removed therefrom, from a point diagonally above and frontward and rightward thereof;

FIG. 7 is a perspective view of the photosensitive-member cartridge with the upper registration roller attached thereto, from a point diagonally above and frontward and rightward thereof;

FIG. 8 is a perspective view of the photosensitive-member cartridge with the upper registration roller attached thereto, from a point diagonally above and frontward and leftward thereof;

FIG. 9 is a perspective view of the photosensitive-member cartridge with the upper registration roller attached thereto and with a photosensitive drum and an upper frame being removed therefrom, from a point diagonally below and rearward and rightward thereof;

FIG. 10 is a side view of the photosensitive-member cartridge;

FIG. 11 is a cross-sectional view of the photosensitive-member cartridge taken along a XI-XI line in FIG. 4;

FIG. 12 is a cross-sectional view of the photosensitive-member cartridge taken along a XII-XII line in FIG. 4;

FIG. 13 is a cross-sectional view of the photosensitive-member cartridge taken along a XIII-XIII line in FIG. 4;

FIG. 14 is a perspective view of a developing cartridge according to the illustrative aspects of the invention from a point diagonally below;

FIG. 15 is a side view of the developing cartridge in FIG. 14;

FIG. 16 is a bottom view of the developing cartridge in FIG. 14;

FIG. 17 is a side view of the developing cartridge completely attached to the photosensitive-member cartridge;

FIG. 18 is a view describing attachment of the process cartridge to a main casing of the laser printer;

FIG. 19 is a view describing attachment of the process cartridge to the main casing of the laser printer;

FIG. 20 is a view describing attachment of the process cartridge to the main casing of the laser printer;

FIG. 21 is a view describing attachment of the process cartridge to the main casing of the laser printer;

FIG. 22 is a side view of the upper registration roller positioned relative to a lower registration roller when the process cartridge is mounted on the main casing of the laser printer;

FIG. 23 is a view of a state where the photosensitive-member cartridge alone is mounted to the main casing of the laser printer;

FIG. 24 is a perspective view of a developing cartridge according to a modification of the illustrative aspects from a point diagonally below;

FIG. 25 is a side view of the developing cartridge in FIG. 24;

FIG. 26 is a bottom view of the developing cartridge in FIG. 24;

FIG. 27 is a perspective view of a developing cartridge according to another modification of the illustrative aspects, from a point diagonally below;

FIG. 28 is a side view of the developing cartridge in FIG. 27;

FIG. 29 is a bottom view of the developing cartridge in FIG. 27; and

FIG. 30 is a view showing another configuration for positioning the upper registration roller at a retract position with respect to the casing of the photosensitive-member cartridge.

### DETAILED DESCRIPTION

Next, a laser printer according to some aspects of the invention will be described with reference to the accompanying drawings. Note that in the following description, the expressions “front”, “rear”, “left”, “right”, “above”, and “below” are used to define the various parts when the laser printer is disposed in an orientation in which it is intended to be used.

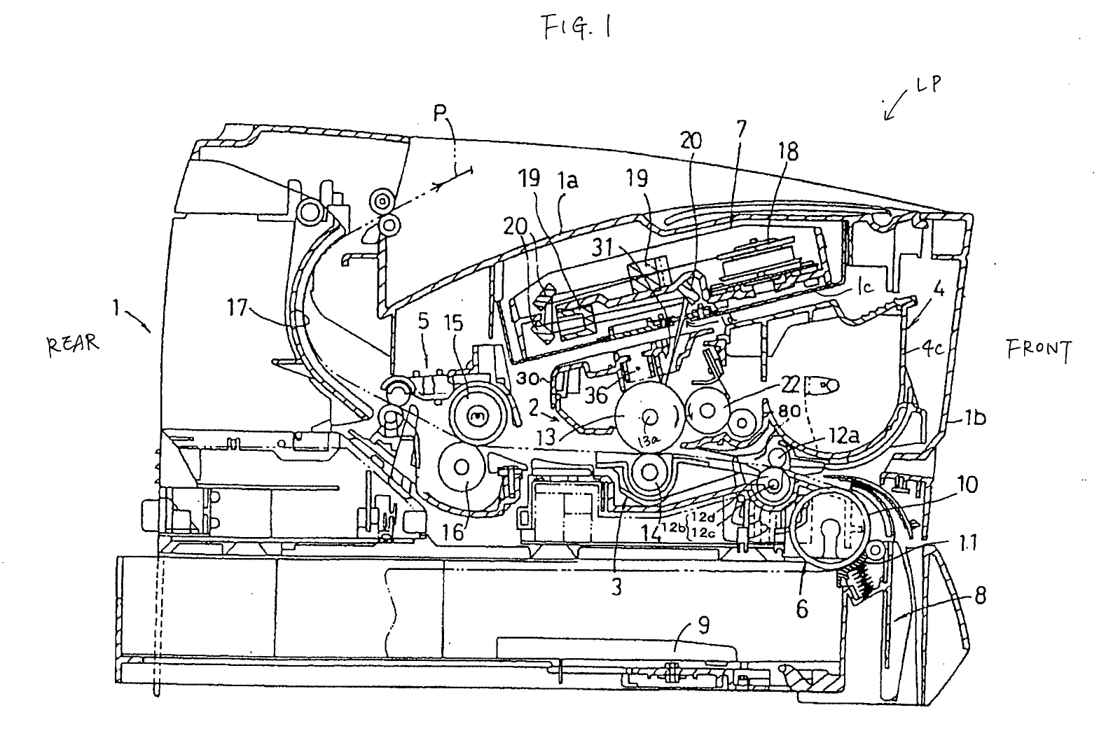

As shown in FIG. 1, a laser printer LP according to illustrative aspects of the invention includes a housing 1 and a process cartridge 2 accommodated in a substantially center section of the housing 1. The process cartridge 2 is detachable from the housing 1 through the front face of the housing 1. The process cartridge 2 includes a photosensitive-member cartridge 3 and a developing cartridge 4 detachably mounted to the photosensitive-member cartridge 3.

The photosensitive-member cartridge 3 includes a photosensitive drum 13, a transfer roller 14, a charger 36, and a casing 30. The photosensitive drum 13 has a shaft 13a and a photosensitive surface formed of an organic photosensitive member or the like, and is disposed so as to be freely rotatable. The transfer roller 14 is disposed below the photosensitive drum 13 so as to rotate while contacting the lower surface of the photosensitive drum 13. The charger 36 is disposed above the photosensitive drum 13 for charging the photosensitive surface of the photosensitive drum 13. The charger 36 is a Scorotron charger, for example. The casing 30 is formed with a light inlet port 31 elongated along an axial direction of the photosensitive drum 13 at a position adjacent to the charger 36.

The developing cartridge 4 includes a casing 4c that houses toner as developer and a developing roller 22. The developing roller 22 is rotatably disposed in confrontation with the photosensitive drum 13. Toner supplied onto the developing roller 22 forms a thin layer on the surface of the developing roller 22, and rotation of the developing roller 22 conveys the toner to a position where the developing roller 22 faces the photosensitive drum 13.

The laser printer LP further includes a fixing unit 5, a discharge sheet tray 1a, a laser scanning unit 7, and a sheet feeder 6.

The fixing unit 5 is disposed downstream of the process cartridge 2 in a conveying direction of paper P, and includes a heat roller 15 and a pressure roller 16.

The discharge sheet tray 1a is made of synthetic resin and is provided to the upper section of the housing 1 for receiving paper P discharged from the fixing unit 5. The discharge sheet tray 1a also serves as a cover.

The laser scanning unit 7 is supported on a frame 1c at a position below the discharge sheet tray 1a, and includes a laser light-emitting portion (not shown), a polygon mirror 18, a lens 19, a plurality of reflecting mirrors 20 and the like.

The sheet feeder 6 is disposed below the process cartridge 2, and includes a sheet cassette 8, a support plate 9, a sheet feed roller 10, and a separator pad 11. The sheet cassette 8 is attachable to a lower portion of the housing 1 by moving the sheet cassette 8 from through the front face of the housing 1. The support plate 9 supports a stack of paper P inside the sheet cassette 8. The sheet feed roller 10 picks up paper P from the support plate 9, and the separator pad 11 separates the paper P one sheet at a time.

The laser printer LP further includes a pair of registration rollers 12a, 12b disposed downstream of the sheet feeder 6 in the sheet feed direction.

The registration rollers 12a, 12b are for conveying the paper P supplied from the sheet feeder 6 to a contact portion between the photosensitive drum 13 and the transfer roller 14 at precise timing.

The upper registration roller 12a is made of metal such as plated iron or stainless steel and has a length longer than the width of the paper P. The lower registration roller 12b includes a shaft 12c covered with an elastic layer 12d. The shaft 12c is made of metal such as plated iron or stainless steel, and the elastic layer 12d is made of urethane rubber or the like. The shaft 12c is rotatably supported by the housing 1. Although not shown in the drawings, the shaft 12c is coupled to a driving source, such as a motor, through a gear or the like, and the timing of start rotating and speed of the rotation of the shaft 12c is controlled by a control unit.

In the illustrative aspects, the upper registration roller 12a is provided to the photosensitive-member cartridge 3, and the lower registration roller 12b is provided to a main body of the laser printer LP. Thus, the process cartridge 2, that is, the photosensitive-member cartridge 3 with the developing cartridge 4 attached thereto can be easily taken out of the main body of the laser printer LP from the front face side of the laser printer LP.

With this configuration, when print data is transmitted to the laser printer LP from an eternal apparatus, for example, a personal computer, a paper P is separated from a stack of sheets P on the support plate 9 one sheet at a time by the separator pad 11 as the sheet feed roller 10 rotates. The separated paper P is conveyed to the contact portion between the photosensitive drum 13 and the transfer roller 14 via the pair of registration rollers 12a, 12b.

On the other hand, the surface of the photosensitive drum 13 is uniformly charged by the charger 36. A laser beam is emitted from the laser scanning unit 7 through a light-emitting hole 1d formed on a lower portion of the frame 1c. The laser beam travels through the light inlet port 31 of the casing 30 and scans an upper peripheral surface portion of the rotating photosensitive drum 13, thereby forming an electrostatic latent image thereon.

Rotation of the developing roller 22 conveys the thin layer of the toner formed on the developing roller 22 to an area opposed to the electrostatic latent image. As a result, the electrostatic latent image is developed into a visible image with the toner, and the visible toner image is transferred onto the paper P at a transfer position between the transfer roller 14 and the photosensitive drum 13. After the transfer operation, the toner image is thermally fixed onto the paper P as the paper P is conveyed between the heat roller 15 and the pressure roller 16 in the fixing unit 5. Thereafter, the paper P is discharged onto the discharge sheet tray 1a through a sheet discharge path 17.

When the toner is consumed with such printing operation, causing a need to supply the toner, first the process cartridge 2 is pulled out of the housing 1 through the front surface of the housing 1, and the developing cartridge 4 is removed from the process cartridge 2. Then, a new developing cartridge 4 is attached to the process cartridge 2, and the process cartridge 2 is mounted on the housing 1 through the front surface of the housing 1. In this manner, a user can easily supply the toner without getting his/her hand soiled. Also, when the photosensitive drum 13 deteriorates, the process cartridge 2 is removed from the housing 1 in the same manner, and the photosensitive-member cartridge 3 is replaced with a new one. After that, the process cartridge 2 is attached to the housing 1 of the laser printer LP.

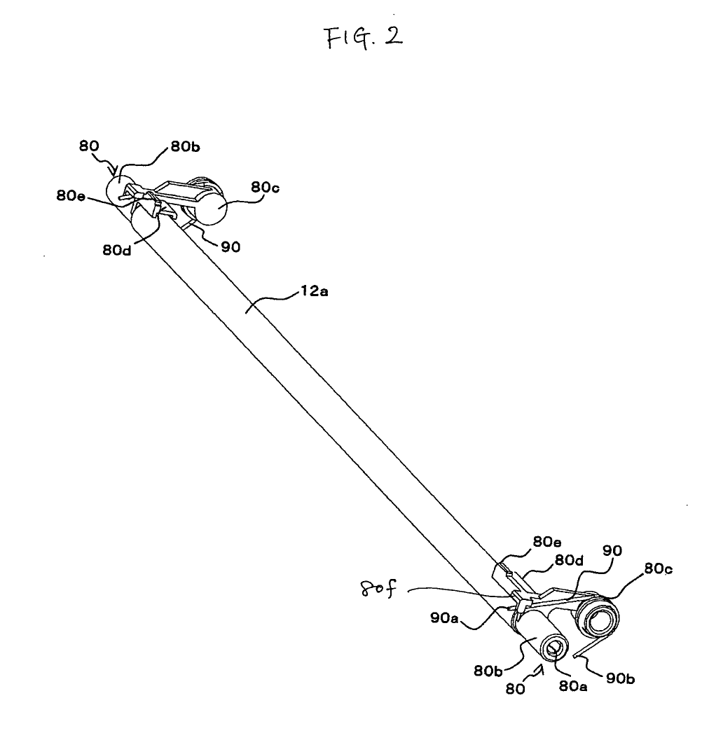

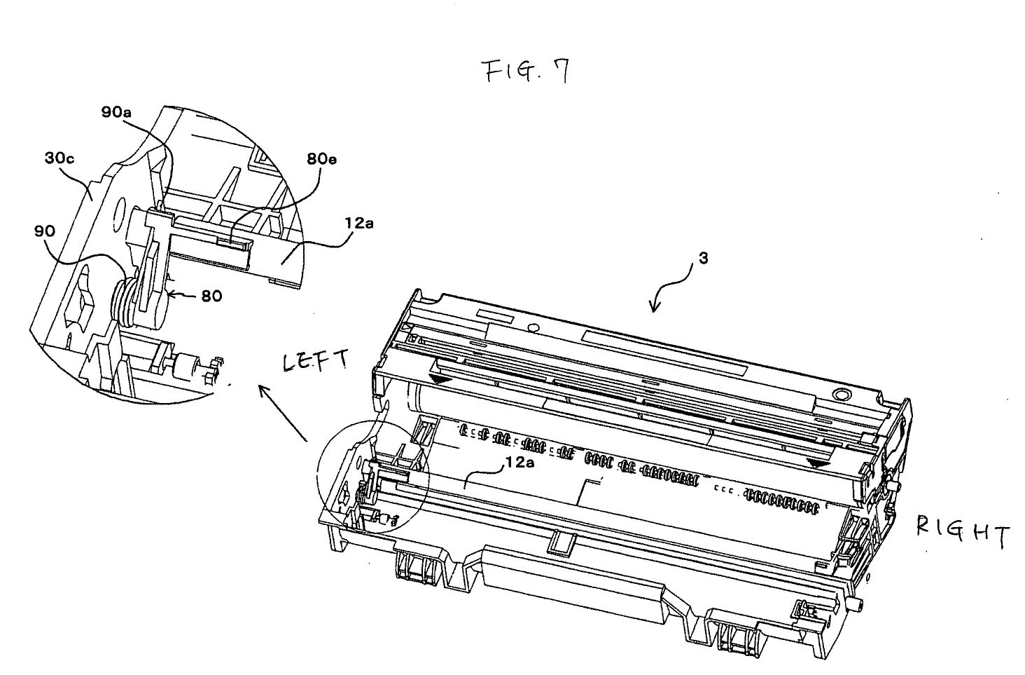

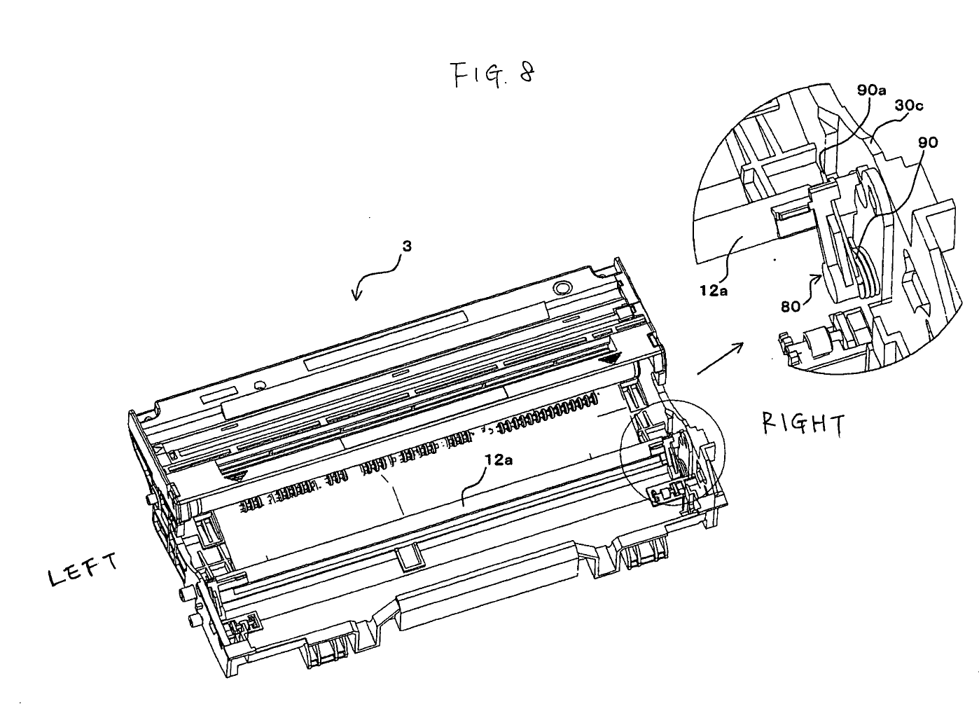

Next, the photosensitive-member cartridge 3 and the developing cartridge 4 will be described further in detail while reference to FIGS. 2 to 9.

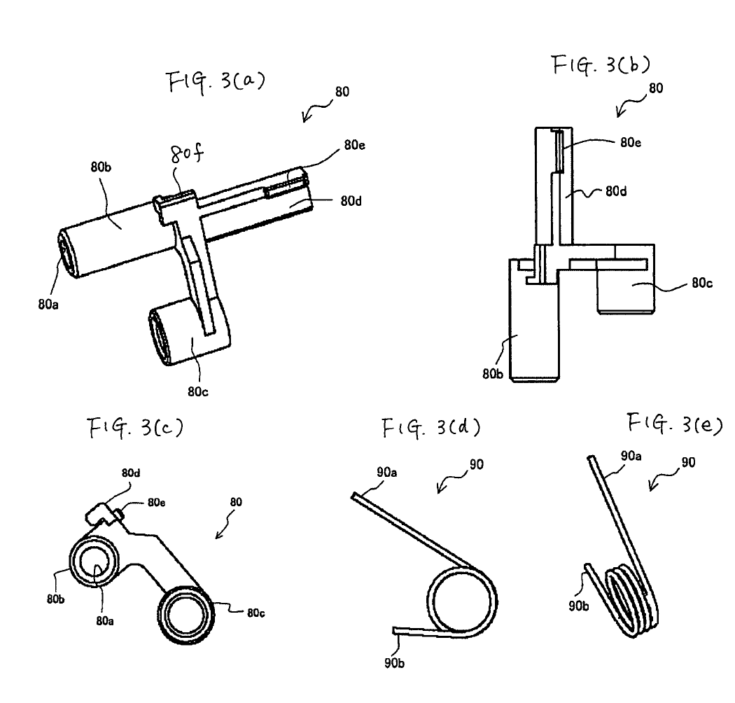

As shown in FIG. 2, roller support members 80 made of resin are attached to the both ends of the upper registration roller 12a. As shown in FIGS. 3(a) to 3(c), each roller support member 80 integrally includes a cylindrical member 80b formed with an inserting hole 80a, a wall-side cylindrical member 80c, a holding member 80d, an engaging member 80e formed on the holding member 80d, and a spring supporting member 80f.

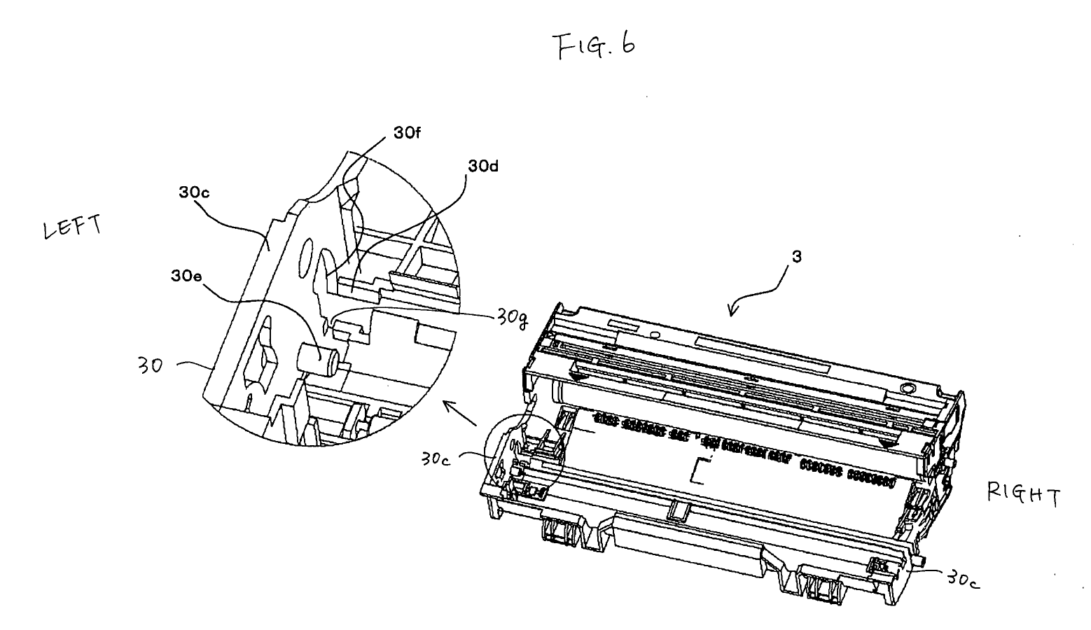

As shown in FIG. 6, the casing 30 of the photosensitive-member cartridge 3 has a pair of right and left side walls 30c and a bottom wall 30d. A protrusion 30e is formed on each of the side walls 30c. The wall-side cylindrical members 80c of the roller support members 80 are fitted to the corresponding protrusions 30e. The side walls 30c are formed with respective notch portions 30f, and the cylindrical members 80b of the roller support members 80 are fitted to the corresponding notch portions 30f.

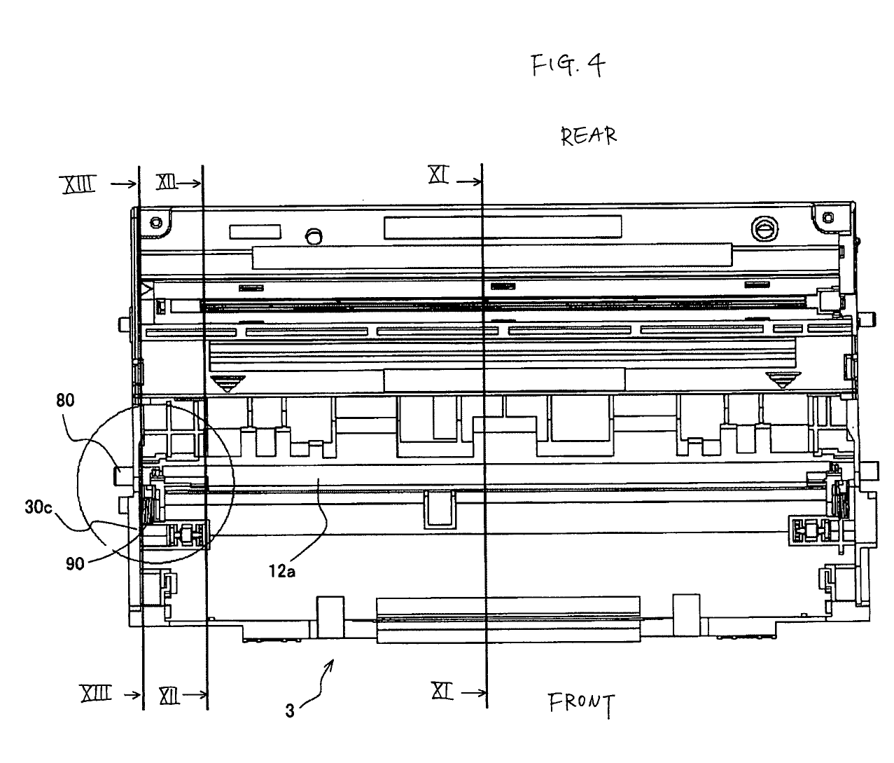

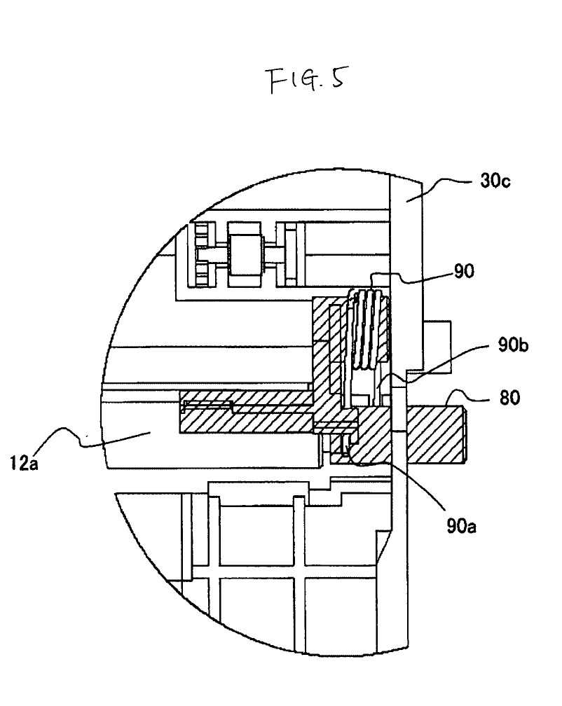

With this configuration, the upper registration roller 12a is supported on the casing 30 as shown in FIGS. 4 and 5 and so as to be movable with respect to the casing 30 along the notch portions 30f shown in FIG. 6 in the vertical direction.

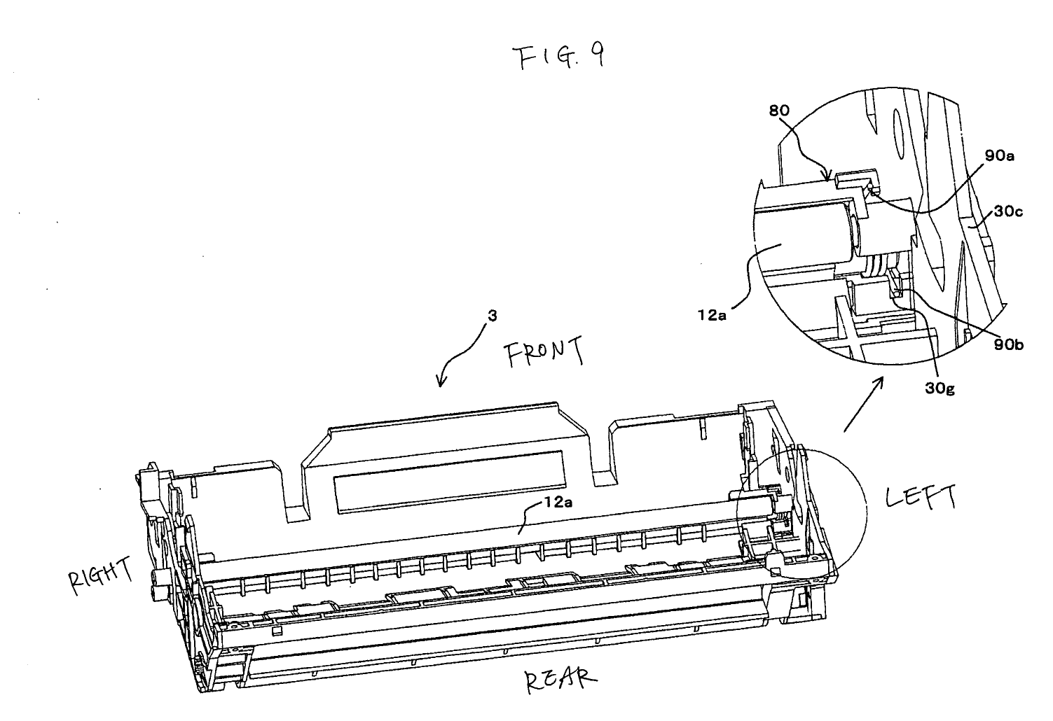

Torsion coil springs 90 shown in FIGS. 3(d) and 3(e) are attached to the roller support members 80. Specifically, as shown in FIGS. 2, 7 and 8, one end 90a of each of the torsion coil springs 90 is supported on the corresponding roller support member 80 at the spring supporting member 80f, and as shown in FIG. 9, the other end 90b is supported on the casing 30 at a recessed part 30g formed in the side wall 30c. The torsion coil springs 90 urge the upper registration roller 12a toward the inside of the casing 30 through the roller support members 80, that is, upwards relative to the bottom wall 30d.

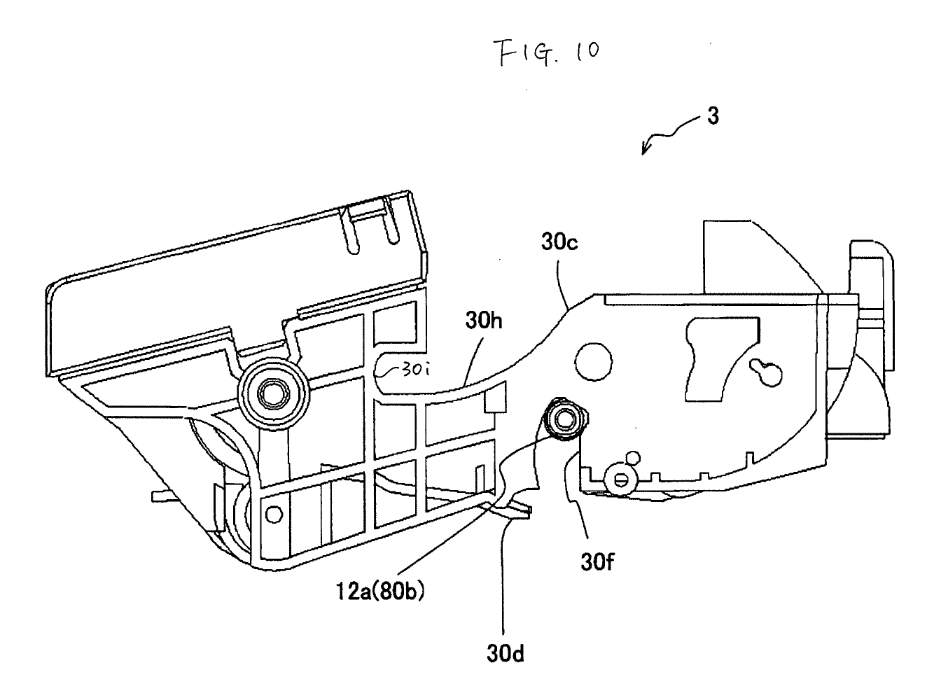

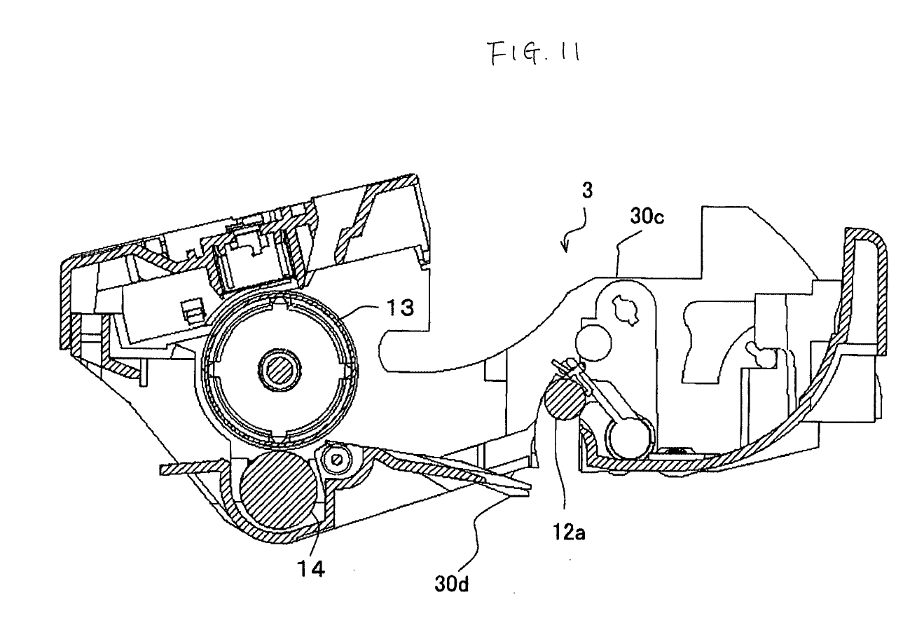

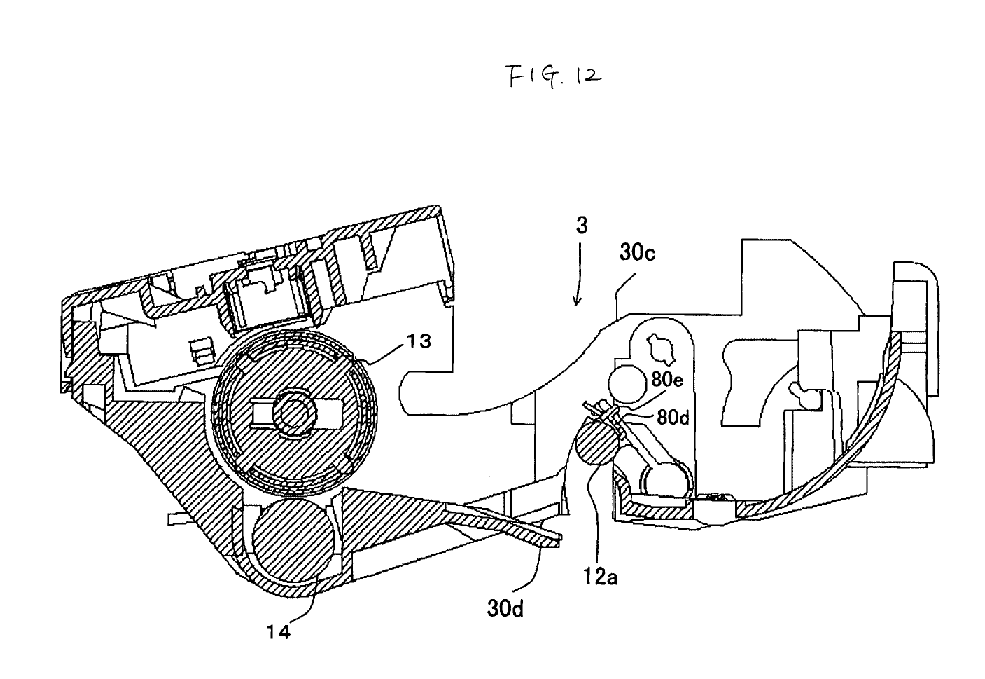

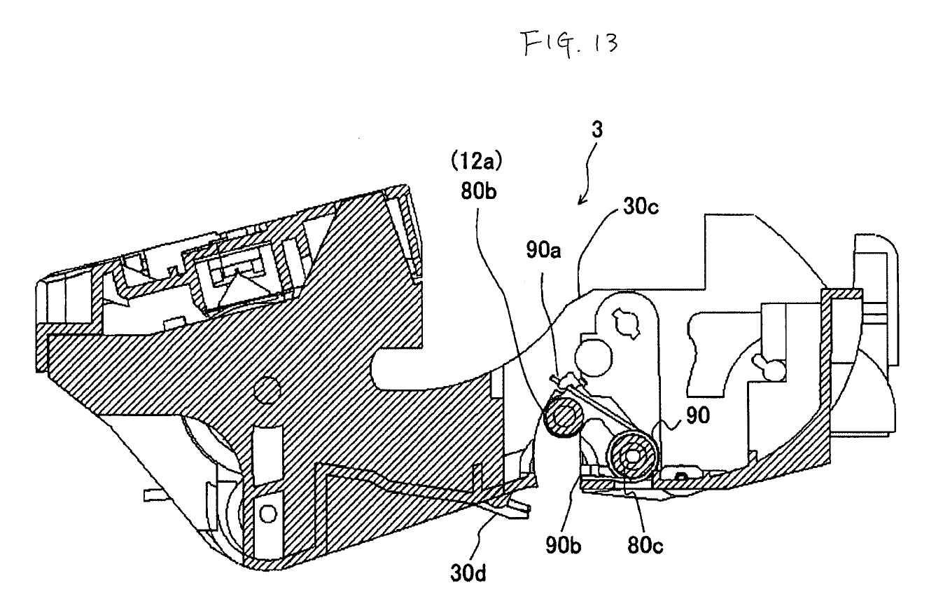

With this configuration, when the photosensitive-member cartridge 3 is alone (i.e., when the photosensitive member cartridge 3 is removed from the housing 1, and the developing cartridge 4 is not attached to the photosensitive member cartridge 3), as shown in FIG. 10, the upper registration roller 12a is held at a retract position where the cylindrical members 80b of the roller support members 80 abut against the upper edges of the notch portions 30f due to urging force of the torsion coil springs 90. Therefore, the upper registration roller 12a does not rattle or protrude beyond the bottom surface of the casing 30, and thus the upper registration roller 12a does not become an obstacle when a user handles the photosensitive-member cartridge 3.

Also, it is possible to easily adjust the retract position (how much the upper registration roller 12a is retracted upward in the casing 30) by modifying the depth of the notch portions 30f in the side walls 30c.

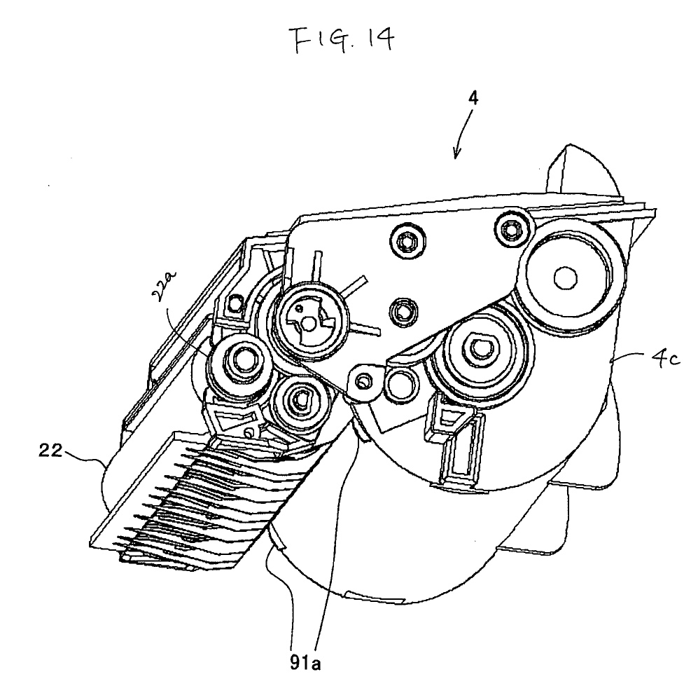

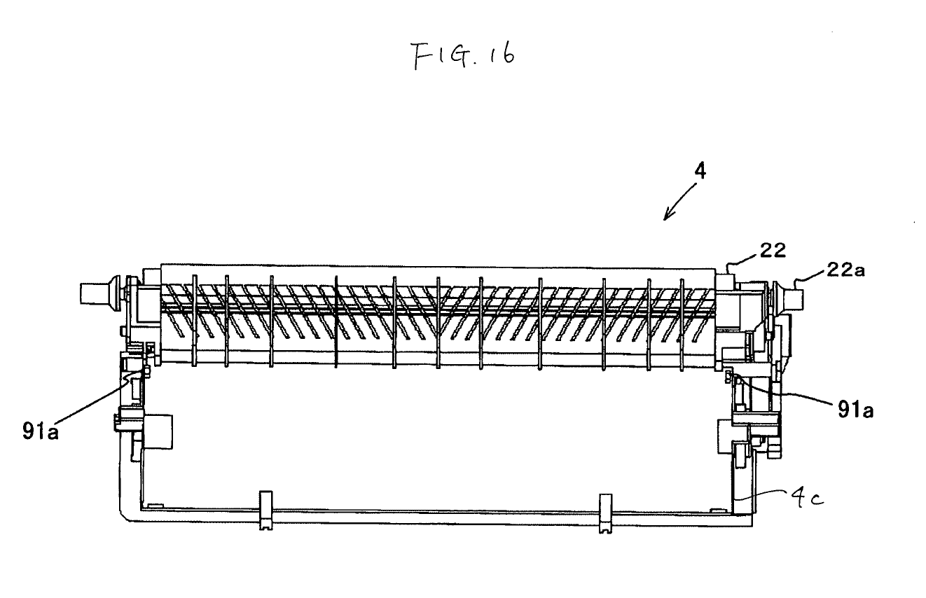

As shown in FIGS. 14 to 16, the developing roller 22 has bearings 22a at both ends, and pressing parts 91a protrude from both ends of the bottom surface of the casing 4c of the developing cartridge 4.

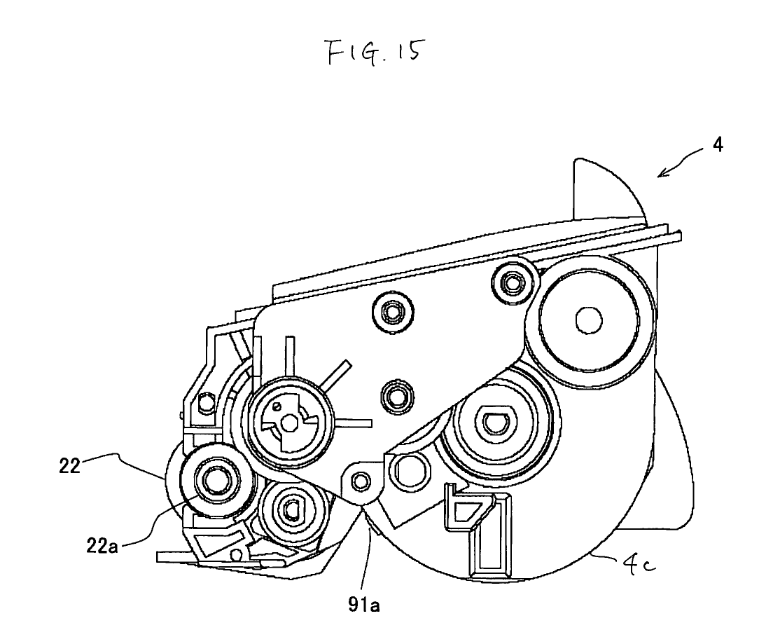

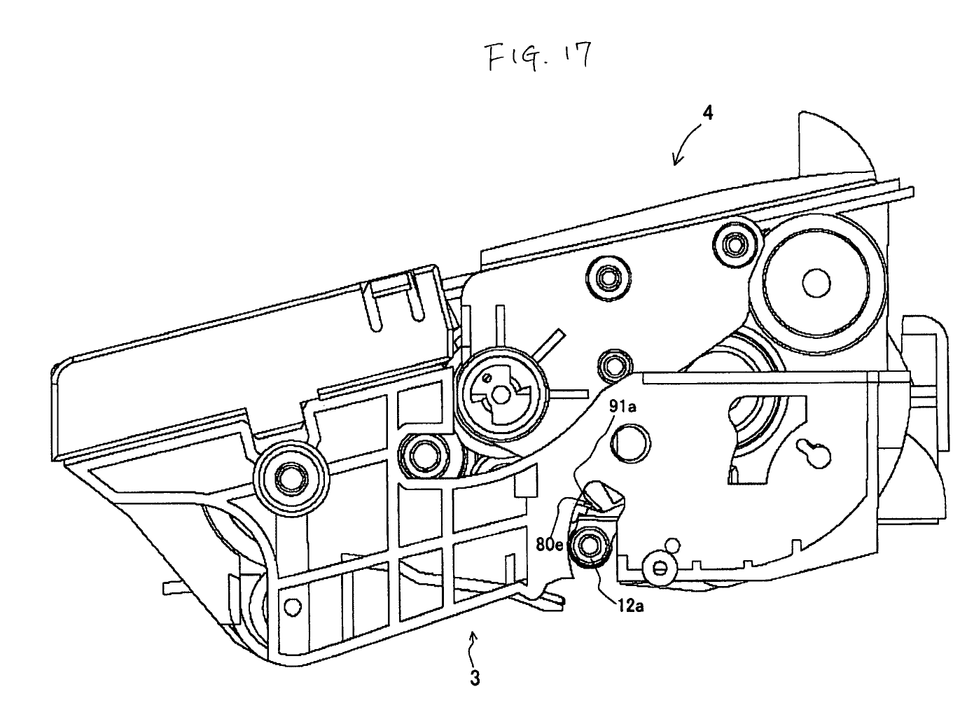

As shown in FIG. 10, guiding parts 30h are formed in the side walls 30c of the photosensitive member cartridge 3. When a user attaches the developing cartridge 4 to the photosensitive-member cartridge 3, the bearings 22a of the developing roller 22 (FIG. 15) move along the guiding parts 30h. In the course of attachment, the pressing parts 91a formed on the bottom surface of the developing cartridge 4 come into contact with the engaging members 80e of the roller support members 80 attached to the both ends of the upper registration roller 12a at the retract position, and then press the engaging members 80e downward. As a result, against the upward urging force of the torsion coil springs 90, the upper registration roller 12a supported by the roller support members 80 is also pressed downward and moved to a position below the retract position. When the bearings 22a reaches deepest positions 30i of the guiding parts 30h and the developing cartridge 4 is completely attached to the photosensitive-member cartridge 3, the pressing parts 91a do not further press the developing cartridge 4, and as shown in FIG. 17, the upper registration roller 12a is held at a working position below the retract position without rattling. Then, the developing cartridge 4 is locked relative to the photosensitive-member cartridge 3 by a locking member not shown.

In this state, the upper registration roller 12a cannot move upward due to the presence of the developing cartridge 4, while the upper registration roller 12a can move downward against the urging force of the torsion coil spring 90 when downward force is applied to the cylindrical members 80b of the roller support members 80 protruding outward from the side walls 30c through the notch portions 30f.

As described above, in the illustrative aspects, only by the simple operation of attaching the developing cartridge 4 to the photosensitive-member cartridge 3, the upper registration roller 12a can be pressed downward and moved to the working position. Also, since the upper registration roller 12a does not rattle even when handling the photosensitive-member cartridge 3 attached with the developing cartridge 4, the handling of the photosensitive-member cartridge 3 is easy.

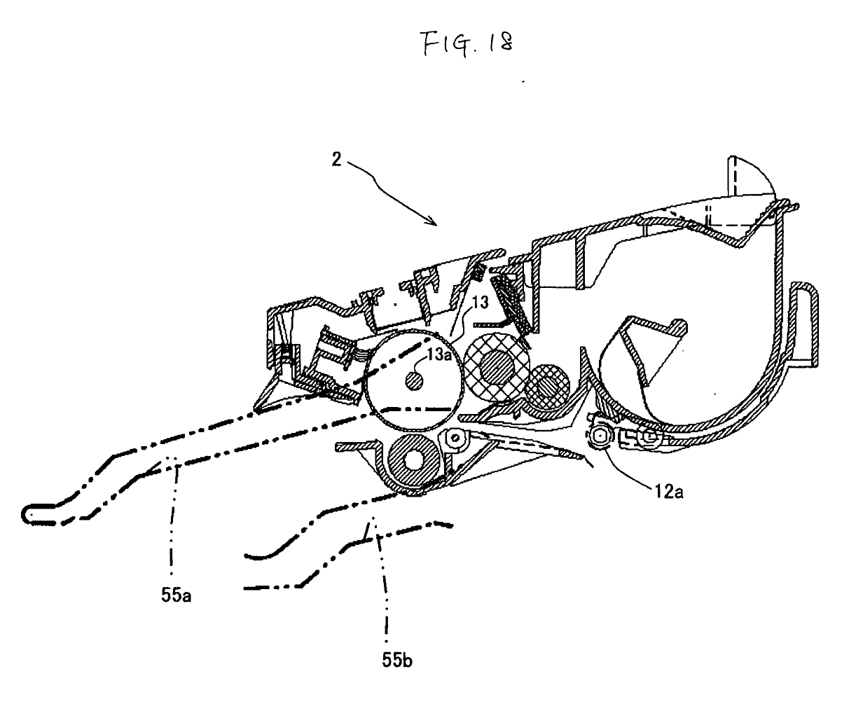

Next, description will be provided for an operation of attaching the process cartridge 2 (the photosensitive member cartridge 3 and the developing cartridge 4 attached to the photosensitive-member cartridge 3) to the housing 1, and for a positioning mechanism for positioning the upper registration roller 12a, with reference to FIGS. 18 to 23.

The attachment and detachment of the process cartridge 2 is performed in the state where a front cover 1b (FIG. 1) of the housing 1 is pivoted downward to widely open.

As shown in FIG. 18, an upper guiding groove 55a and a lower guiding groove 55b are formed on an inner surface of each of right and left side plates of the housing 1. The upper guiding groove 55a and the lower guiding groove 55b extend in substantially parallel to each other and incline downward.

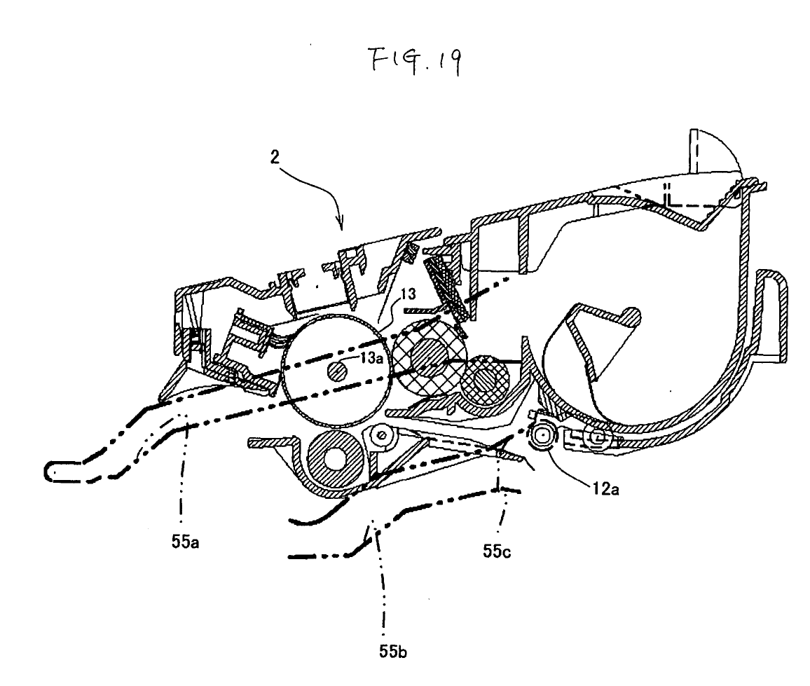

FIG. 18 shows the process cartridge 2 located at a start position of insertion into the housing 1. By inserting the process cartridge 2 into the housing 1 from the location shown in FIG. 18, as shown in FIG. 19 the shaft 13a of the photosensitive drum 13 is guided along the upper guiding grooves 55a, and the upper registration roller 12a is guided along the lower guiding grooves 55b while contacting upper surfaces 55c of the lower guiding grooves 55b.

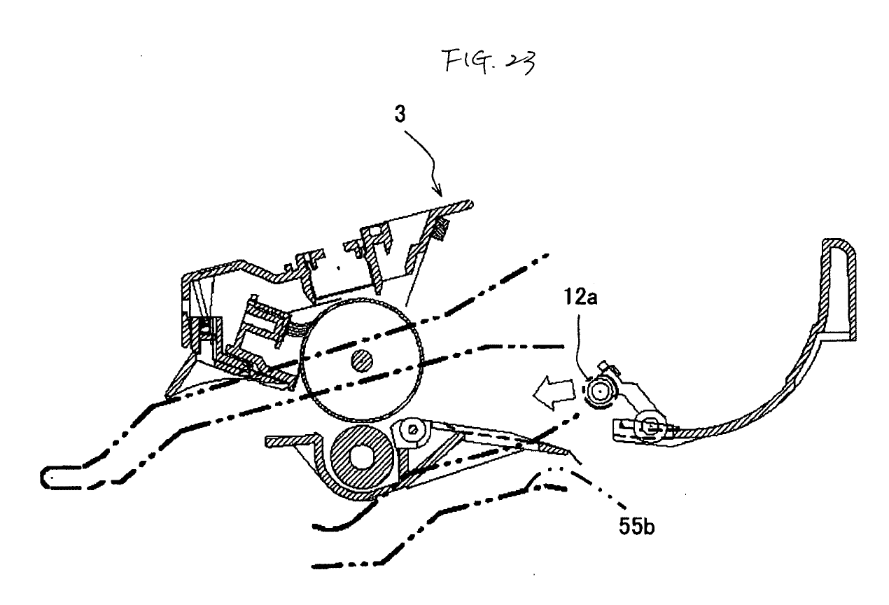

Note that when the user intends to only attach the photosensitive-member cartridge 3 to the housing 1 without the developing cartridge 4 attached to the photosensitive member cartridge 3, as shown in FIG. 23, the upper registration roller 12a cannot engage with the lower guiding grooves 55b because the upper registration roller 12a is retracted to the retract position. Accordingly, the photosensitive-member cartridge 3 alone cannot be attached to the housing 1.

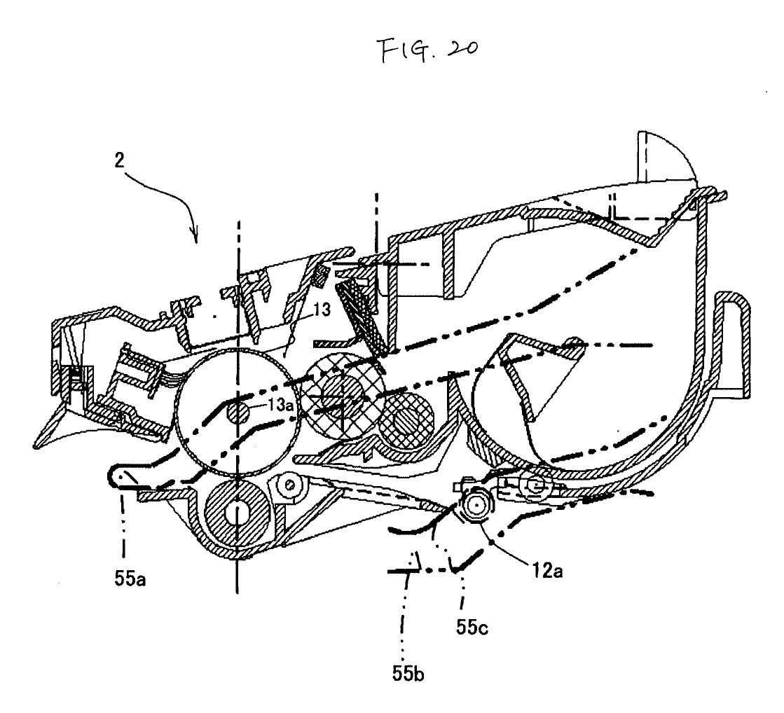

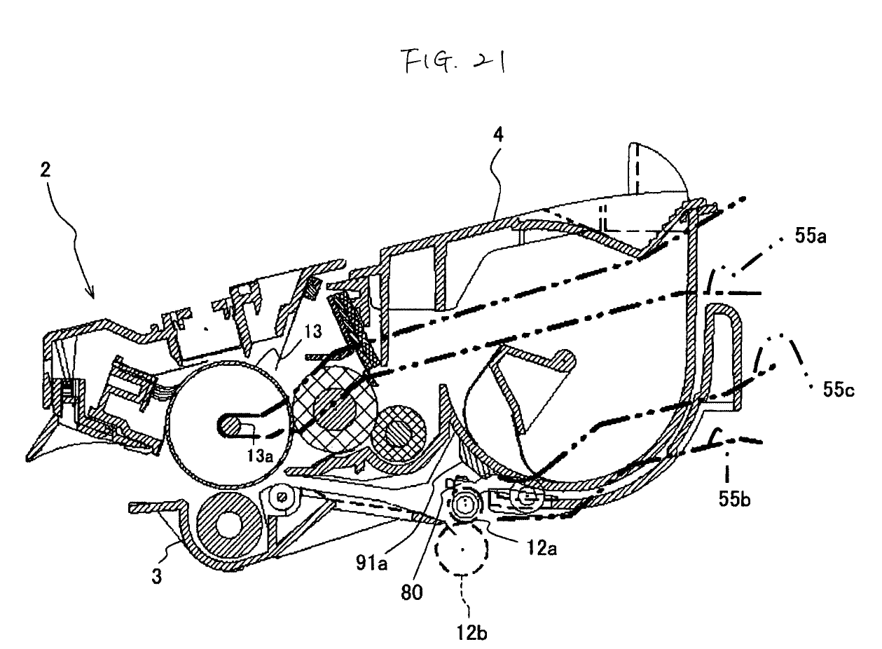

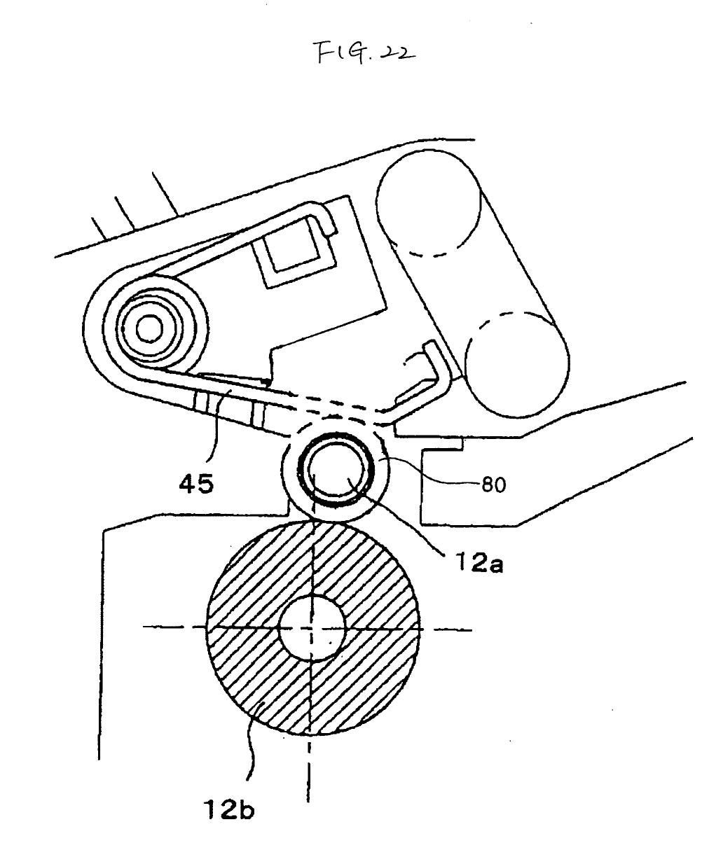

When the process cartridge 2 is inserted deeper, the upper registration roller 12a moves downward along the upper surface 55c of the lower guiding groove 55b as shown in FIG. 20. When the shaft 13a of the photosensitive drum 13 reaches the deepest ends of the upper guiding grooves 55a as shown in FIG. 21, the process cartridge 2 is prevented from further moving inward, and the upper registration roller 12a is located off the lower guiding grooves 55b. In this state, the upper registration roller 12a at the working position opposes the lower registration roller 12b. When the user moves his/her hands off the process cartridge 2 in this state, as shown in FIG. 22 the roller support members 80 engage with springs 45 disposed on the side walls of the housing 1. The roller support members 80 attached to the both ends of the upper registration roller 12a are pressed downward by the springs 45, and the upper registration roller 12a moves to a conveying position below the working position. At the conveying position, the upper registration roller 12a opposes the lower registration roller 12b and can convey the paper P in cooperation with the lower registration roller 12b.

Here, the urging force of the springs 45 urging the upper registration roller 12a against the lower registration roller 12b is larger than the urging force of the torsion coil springs 90 urging the upper registration roller 12a toward the retract position. Therefore, the upper registration roller 12a is positioned in pressed contact with the lower registration roller 12b at proper position and angle with respect to the lower registration roller 12b with proper pressing force. Accordingly, the upper registration roller 12a can properly contact the lower registration roller 12b, and thus the proper relationship between the upper registration roller 12a and the lower registration roller 12b can be maintained all the time. As a result, the paper P can be stably conveyed at any time.

As shown in FIG. 21, when the upper registration roller 12a is at the conveying position, the pressing parts 91a of the developing cartridge 4 separate from the roller support members 80. Consequently, the pressing of the developing cartridge 4 can be prevented from acting on the contact state of the upper registration roller 12a with the lower registration roller 12b. Therefore, the pressing parts 91a of the developing cartridge 4 can be prevented from exerting a harmful influence on the image quality, and deterioration in the image can be prevented.

As described above, according to the illustrative aspects, when the photosensitive-member cartridge 3 is alone, the upper registration roller 12a is held at the retract position above the bottom surface of the casing 30. Therefore, the upper registration roller 12a does not rattle or protrude beyond the bottom surface of the casing 30 to become an obstacle. Also, when the developing cartridge 4 is attached to the photosensitive-member cartridge 3, the upper registration roller 12a is held at the working position. Thus, when handling the photosensitive-member cartridge 3 attached with the developing cartridge 4, the upper registration roller 12a does not rattle, thereby facilitating handling.

Since the pair of torsion coil springs 90 urge the respective roller support members 80 that rotatably support the upper registration roller 12a, it is possible to urge the upper registration roller 12a without needing a complicated urging mechanism. Also, the roller support members 80 and the torsion coil springs 90 do not interrupt conveyance of the paper P.

Further, because the roller support members 80 are used for supporting the upper registration roller 12a, the upper registration roller 12a can be supported so as to be movable with respect to the casing 30 with a simple configuration.

Since only attachment of the developing cartridge 4 onto the photosensitive-member cartridge 3 presses the upper registration roller 12a through the pressing parts 91a, a complicated pressing mechanism is unnecessary. Since the pressing parts 91a are disposed to oppose the roller support members 80, the pressing parts 91a can press the upper registration roller 12a uniformly with respect to the longitudinal direction of the roller support members 80 or the upper registration roller 12a.

Furthermore, since the pressing parts 91a press the upper registration roller 12a through the roller support members 80, the pressing parts 91a can move the upper registration roller 12a without harming the upper registration roller 12a.

While the invention has been described in detail with reference to the above aspects thereof, it would be apparent to those skilled in the art that various changes and modifications may be made therein without departing from the spirit of the invention.

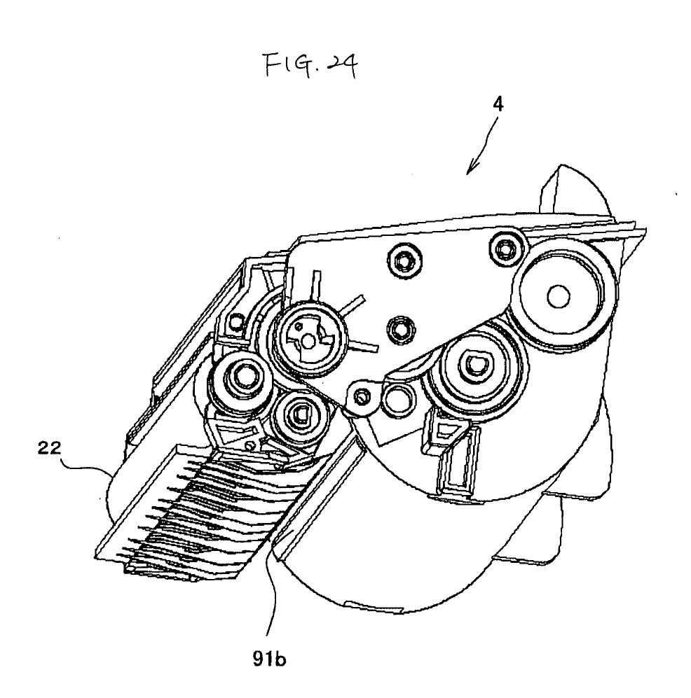

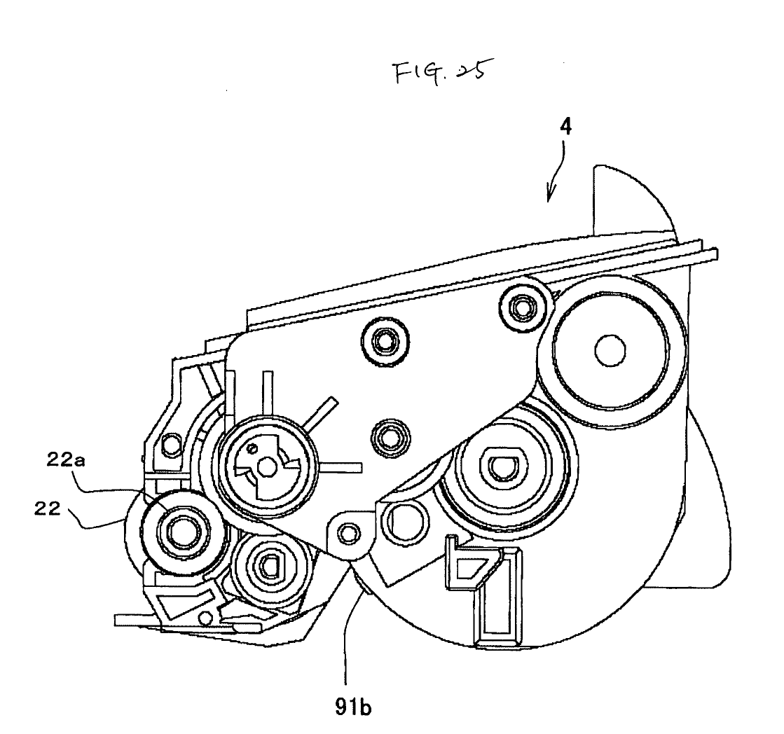

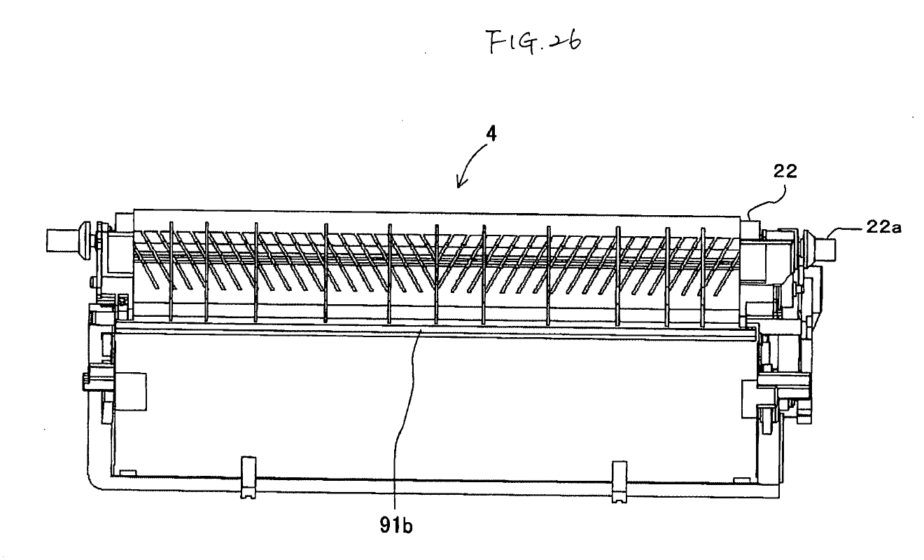

For example, as shown in FIG. 24 to FIG. 26, the developing cartridge 4 may be formed with a pressing part 91b instead of the pressing parts 91a. Specifically, the pressing part 91b protrudes from the bottom surface of the developing cartridge 4 and extends in parallel with the axis of the developing roller 22. The pressing part 91b is elongated to contact the engaging members 80e of the roller support members 80 on the both ends of the upper registration roller 12a when the developing cartridge 4 is attached to the photosensitive-member cartridge 3.

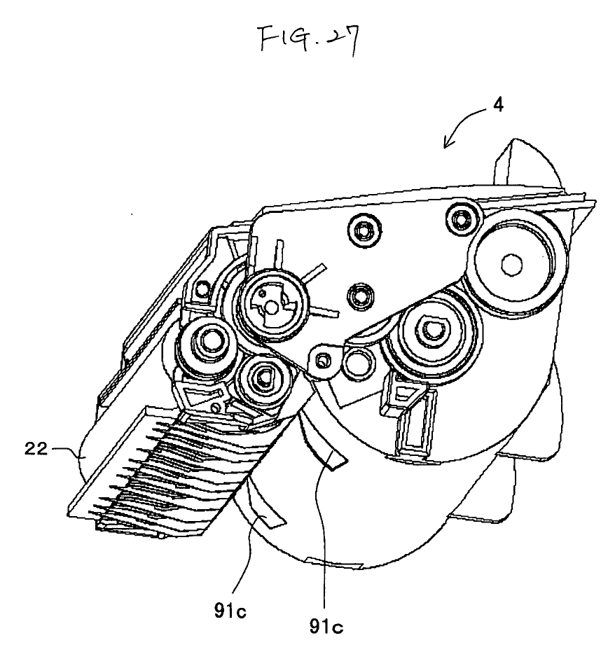

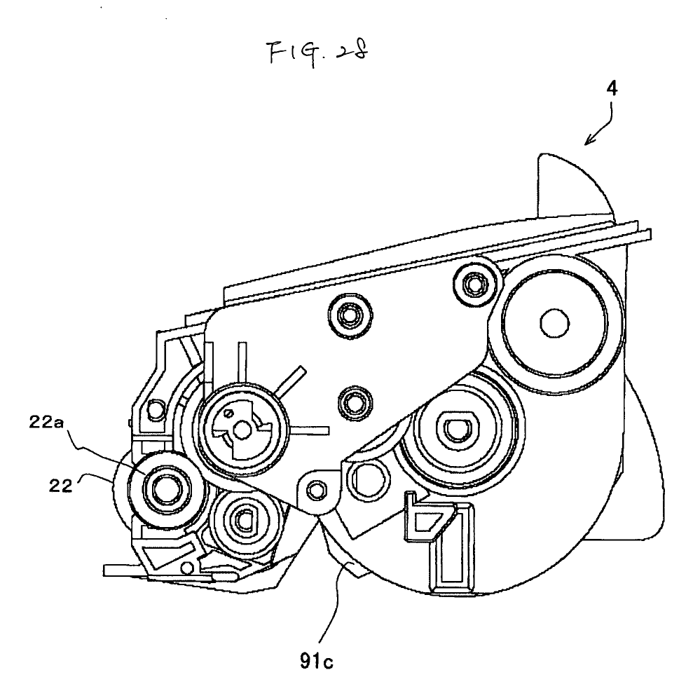

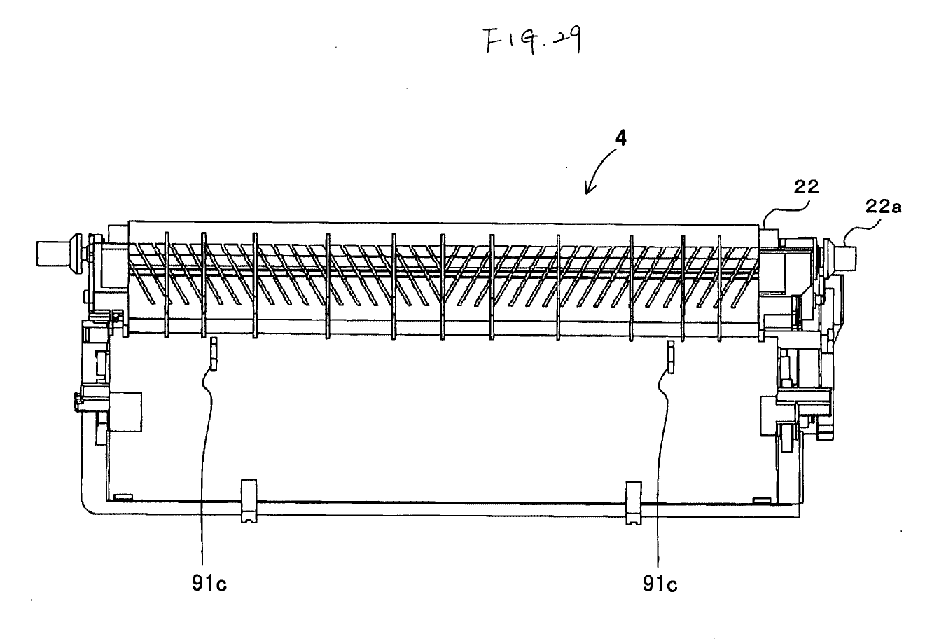

Alternatively, the developing cartridge 4 may be formed with pressing parts 91c shown in FIGS. 27 to 29 in place of the pressing parts 91a. Specifically, the pressing parts 91c protrude from the bottom surface of the developing cartridge 4, at positions opposed to the upper registration roller 12a when the developing cartridge 4 is attached to the photosensitive-member cartridge 3. Thus, when the developing cartridge 4 is attached to the photosensitive-member cartridge 3, the pressing parts 91c press the upper registration roller 12a downward against the urging force of the torsion coil springs 90. With this configuration, since the pressing parts 91c directly press the upper registration roller 12a , the pressing force of the pressing parts 91c can be stably transmitted to the upper registration roller 12a to move the upper registration roller 12a. Since the pressing parts 91c are formed integrally with the casing 4c of the developing cartridge 4, the developing cartridge 4 can have a simple configuration.

Also, the above-described pressing parts 91a to 91c are not necessarily formed integrally with the casing 4c of the developing cartridge 4. The pressing parts 91a to 91c may be formed separate from the casing 4c of the developing cartridge 4 and attached to the bottom surface of the casing.

In the above-described aspects, the roller support members 80 shown in FIGS. 3(a) to 3(c) are used for supporting the upper registration roller 12a. However, a different member may be used as long as the member can rotatably support the upper registration roller 12a with respect to the casing 30 of the photosensitive-member cartridge 3.

In the above-described aspects, the torsion coil springs 90 shown in FIGS. 3(d) and 3(e) are used for urging the upper registration roller 12a. However, a different spring may be used as long as the spring can urge the upper registration roller 12a toward the retract position.

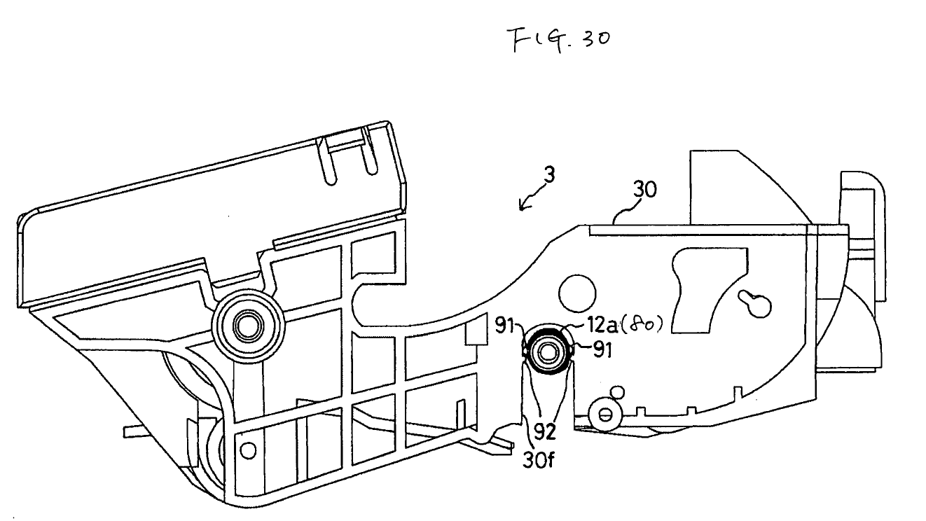

In the above-mentioned aspects, the torsion coil springs 90 are used for holding the upper registration roller 12a while preventing the upper registration roller 12a from rattling with respect to the casing 30 of the photosensitive-member cartridge 3. However, a different configuration is possible for holding the upper registration roller 12a in this manner. For example, as shown in FIG. 30, engaging parts 91 may be formed on circumferential surfaces of the roller support members 80 so as to protrude outward from the circumferential surfaces, and engaged parts 92 may be formed on inner side surfaces of the notch portions 30f of the casing 30. With this configuration, the upper registration roller 12a is prevented from moving downward by the engaging parts 91 catching on the engaged parts 92, and thus held at the retract position where the upper registration roller 12a abuts against the upper edges of the notch portions 30f and does not rattle. When the developing cartridge 4 is attached to the photosensitive-member cartridge 3, the developing cartridge 4 presses the upper registration roller 12a downward, disengaging the engaging parts 91 from the engaged parts 92. As a result, the upper registration roller 12a moves to the working position.

1. A photosensitive-member cartridge attachable to an image forming device including a device-side roller, the photosensitive-member cartridge comprising:
a photosensitive member on which an electrostatic latent image is formed;
a casing that houses the photosensitive member, wherein a developing cartridge including a developing member that develops the electrostatic latent image into a visible image is detachably attachable to the casing;
a conveying member including a cartridge-side roller supported on the casing so as to be movable relative to the casing, the cartridge-side roller conveying a recording medium in cooperation with the device-side roller; and
a holding member that is disposed between the casing and the conveying member and holds the conveying member, wherein the holding member prevents the conveying member from rattling relative to the casing.

2. The photosensitive-member cartridge according to claim 1, wherein the cartridge-side roller is movable between a first position and a second position outward of the first position with respect to the casing, and the holding member urges the cartridge-side roller toward the first position.

3. The photosensitive-member cartridge according to claim 2, wherein the conveying member further includes a support member that is roatably supported on the casing and rotatably supports the cartridge-side roller.

4. The photosensitive-member cartridge according to claim 3, wherein the holding member is a spring the urges the cartridge-side roller.

5. The photosensitive-member cartridge according to claim 3, wherein the conveying member includes a pair of support members that supports both ends of the cartridge-side roller, wherein the holding member includes a pair of springs that urges the cartridge-side roller.

6. The photosensitive-member cartridge according to claim 3, wherein the conveying member includes an engaging part, and when the developing cartridge is attached to the casing, the engaging part engages with the developing cartridge, thereby moving the cartridge-side roller from the first position to the second position.

7. The photosensitive-member cartridge according to claim 6, wherein the engaging part is formed on the support member.

8. A developing cartridge detachably attachable to a photosensitive-member cartridge including: a photosensitive member on which an electrostatic latent image is formed; a casing that houses the photosensitive member; a conveying member including a cartridge-side roller that conveys a recording medium in cooperation with a device-side roller of an image-forming device and a support member that rotatably supports the cartridge-side roller; and a holding member that holds the conveying member; the developing cartridge comprising:
a developing member that develops the electrostatic latent image formed on the photosensitive member of the photosensitive-member cartridge; and
a pressing member that presses the conveying member of the photosensitive-member cartridge against holding force of the holding member of the photosensitive-member cartridge when the developing cartridge is attached to the photosensitive-member cartridge.

9. The developing cartridge according to claim 8, wherein when the developing cartridge is attached to the photosensitive-member cartridge, the pressing member presses the conveying member of the photosensitive-member cartridge to move the cartridge-side roller outward with respect to the casing of the photosensitive-member cartridge.

10. The developing cartridge according to claim 8, wherein when the developing cartridge is attached to the photosensitive-member cartridge, the pressing member presses the conveying member of the photosensitive-member cartridge to move the cartridge-side roller to a position where the cartridge-side roller of the photosensitive-member cartridge opposes the device-side roller of the image-forming device when the photosensitive-member cartridge with the developing cartridge attached thereto is attached to the image-forming device.

11. The developing cartridge according to claim 8, wherein when the developing cartridge is attached to the photosensitive-member cartridge, the pressing member presses the cartridge-side roller through the support member of the photosensitive-member cartridge.

12. The developing cartridge according to claim 8, wherein when the developing cartridge is attached to the photosensitive-member cartridge, the pressing member presses the cartridge-side roller of the photosensitive-member cartridge.

13. The developing cartridge according to claim 8, wherein the pressing member is disposed at a position where the pressing member opposes the support member of the photosensitive-member cartridge when the developing cartridge is attached to the photosensitive-member cartridge.

14. The developing cartridge according to claim 8, wherein the pressing member is disposed at a position where the pressing member opposes the cartridge-side roller of the photosensitive-member cartridge when the developing cartridge is attached to the photosensitive-member cartridge.

15. The developing cartridge according to claim 8, wherein the pressing member is protrusions disposed at least at positions to oppose both ends of the conveying member of the photosensitive-member cartridge when the developing cartridge is attached to the photosensitive-member cartridge.

16. The developing cartridge according to claim 14, further comprising a casing, wherein the pressing member is formed integrally with the casing.

17. An image-forming device comprising:
a device-side roller;
a housing that supports the device-side roller;
a photosensitive-member cartridge detachably supported on the housing, the photosensitive-member cartridge including:
a photosensitive member on which an electrostatic latent image is formed;
a cartridge casing that houses the photosensitive member;
a conveying member including a cartridge-side roller and a support member that rotatably supports the cartridge-side roller, the cartridge-side roller conveying a recording medium in cooperation with the device-side roller; and
an urging member that urges the cartridge-side roller toward a retract position;
a developing cartridge detachably attached to the photosensitive-member cartridge, the developing cartridge including:
a developing member that develops the electrostatic latent image formed on the photosensitive member into a visible image; and
a pressing member that presses the cartridge-side roller against urging force of the urging member when the developing cartridge is attached to the photosensitive-member cartridge and the photosensitive-member cartridge is detached from the housing; and
a resilient member that urges the cartridge-side roller against the device-side roller when the photosensitive-member cartridge and the developing cartridge are mounted to the housing, wherein
the urging force of the resilient member is greater than the urging force of the urging member.

18. The image forming device according to claim 17, further comprising a guide member that guides the cartridge-side roller toward a conveying position at which the cartridge-side roller conveys a recording medium in cooperation with the device-side roller when the photosensitive-member cartridge and the developing cartridge are mounted to the housing, wherein when the photosensitive-member cartridge and the developing cartridge are mounted to the housing, the resilient member urges the cartridge-side roller against the device-side roller, moving the cartridge-side roller toward the conveying position.

19. The image forming device according to claim 17, wherein when the photosensitive-member cartridge and the developing cartridge are completely mounted onto the housing, the pressing member separates from the conveying member.
